(19) United States
(12) Patent Application Publication
(10) Pub. No.: US 2008/0112784 A1
(43) Pub. Date: May 15, 2008

(54) Load port door with simplified FOUP door sensing and retaining mechanism

(76) Inventors: Theodore W. Rogers, Alameda, CA (US); Roumen Iliev Deyanov, Santa Clara, CA (US); Anthony McGrogan, San Jose, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/599,020

(22) Filed: Nov. 13, 2006

(51) Int. Cl. B65G 69/00

(52) U.S. Cl. 414/411

(57) ABSTRACT

A load port door for opening a container storing one or more workpieces. The port door includes a pair of latch keys for unlocking the container door from the container shell and coupling the container door to the port door. The port door further includes a retention mechanism for preventing or minimizing motion of the container door relative to the port door while the container door and port door are coupled together. In one embodiment, the retention mechanism includes a plunger that essentially pushes the container door away from the port door and against the back surface of the latch keys. In another embodiment, the retention mechanism comprises a spring-actuated registration pin that pushes the container door away from the port door and against the back surface of the latch keys while the port door and container door are coupled together.

### FIELD OF THE INVENTION

The present invention generally relates to a port door mechanism for retaining the FOUP door in place in relation to the port door. More specifically, the present invention comprises a retention mechanism for pushing the FOUP door away from the port door and against the back of the latch keys and holding the FOUP door in a fixed location relative to the port door while the doors are coupled together.

### BACKGROUND OF THE INVENTION

FIG. 1 is a perspective view of conventional a 300 mm front opening FOUP 20 including a pod door 22 mating with a pod shell 24 to define a sealed environment for one or more workpieces located therein. (The rear of the pod door 20 would ordinarily be facing the port door as the pod is loaded on the port. It is shown otherwise in FIG. 1 for clarity). While pod 20 is illustrated as a 300 mm Front Opening Unified Pod (FOUP), the size and type of the pod are not critical to the present invention. In order to transfer the workpieces between the pod 20 and a process tool 28, the FOUP 20 is loaded onto a load port 25 adjacent a port door 26 on a front of the process tool. The type of process carried out within tool 28 is not critical to the present invention, and may be any of various testing, monitoring, and/or processing operations.

Referring now to FIGS. 1 and 2, a front surface 30 of the port door 26 faces a front surface 31 of the FOUP door 22. The port door 26 includes a pair of latch keys 32 for being received in a corresponding pair of slots 33 of a door latching assembly mounted within FOUP door 22. The latch keys 32 have a body 43 extending rearward therefrom and into the port door 26, and a backside 41. The FOUP door also includes a pair of location features 35 for receiving the pair of registration pins 39 extending from the port door 22. An example of a latch assembly within a FOUP door adapted to receive and operate with a latch key 32 is disclosed in U.S. Pat. No. 4,995,430 entitled “Sealable Transportable Container Having Improved Latch Mechanism,” which is assigned to Asyst Technologies, Inc., and which is incorporated in its entirety by reference herein. In order to latch or couple the FOUP door 22 to the port door 26, the FOUP door 22 is seated on a FOUP advance plate 23 and positioned adjacent the port door 26. Through a combination of moving the FOUP 20 and/or the port door 26, the vertically oriented latch keys 32 are received within the vertically oriented slots 33.

After the latch keys 32 are inserted into the slots 33, the latch keys 32 rotate 90° to a horizontal position. In addition to decoupling the FOUP door 22 from the FOUP shell 24, rotating the latch keys 32 also prevents the FOUP door 22 from sliding off the latch key body 43 because the back surface 41 of the latch keys 32 will act as a stop. Thus, the FOUP door 22 is essentially coupled to the port door 26. An alternative latch key 32 is shown in FIG. 2A, which including rollers 35 mounted on a pin 37 of the key. A conventional load port door includes two latch key 32 while a conventional FOUP 20 includes two slots 33.

After the FOUP door 22 is unlocked from the FOUP shell, but before the FOUP door 22 is removed from the FOUP, many conventional load port doors utilize a vacuum mechanism to “hold” or “pull” the FOUP door 22 against the port door 26. Pulling the FOUP door 22 against the port door 26 is an attempt to prevent the FOUP door 22 from moving relative to the port door 26 as the FOUP door 22 is removed from the FOUP. If the FOUP door 22 moves or slips after being removed from the FOUP, it is often difficult or impossible to place the FOUP door back into the FOUP. Or upon inserting the FOUP door back into the FOUP, the FOUP door will scrape the FOUP and create particles that may damage the wafers stored in the FOUP. These vacuum mechanisms add expense to a load port.

Therefore, there is a need for a load port door that prevents relative motion between the FOUP door and the load port door in a more cost effective and less complex manner. The present invention provides such a load port door.

### SUMMARY OF THE INVENTION

One aspect of the present invention is to provide a port door that prevents or minimizes motion by the FOUP door relative to the port door when the FOUP door is initially removed from the FOUP. In one embodiment, the port door includes a plunger mechanism for pressing the FOUP door against the back of the latch keys to prevent motion relative to the port door after the doors are coupled together. In another embodiment, the port door includes a spring-actuated registration pin for aligning the port door with the FOUP door and pressing the FOUP door against the back of the latch keys. The plunger ______.

Another aspect of the present invention is to reduce the cost of the load port door assembly. In one embodiment, the port door includes a retention mechanism having a reciprocating plunger that pushes the FOUP door away from the port door and against the back of the latch keys to hold the FOUP door in place relative to the port door. In another embodiment, the port door includes a pair of spring-loaded registration pins for pushing the FOUP door away from the port door and against the back of the latch keys and holding the FOUP door in place relative to the port door. These spring-loaded retention devices eliminate the need for complex and more expensive vacuum elements used by conventional load port door to retain a FOUP door relative to the port door. In another embodiment, the port door includes a retention mechanism the comprises a compressible gasket for pushing the FOUP door away from the port door and against the back of the latch keys to hold the FOUP door in place relative to the port door.

### BRIEF DESCRIPTION OF THE DRAWINGS

FIG. 1 provides an isometric view of an embodiment of a FOUP;

FIGS. 2-2A provide isometric views of an embodiment of a load port and its features, according to the prior art;

FIG. 3 provides a rear view of a port door including one embodiment of a latch key drive mechanism;

FIG. 4 provides an isometric view of a load port door including one embodiment of a FOUP door retention mechanism;

FIG. 5 provides a schematic partial cut-away view of the FOUP door retention mechanism shown in FIG. 5;

FIG. 6 provides an isometric view of a load port door including another embodiment of a FOUP door retention mechanism;

FIGS. 7-11 provide schematic views of various embodiments of the FOUP door retention mechanism shown in FIG. 7;

FIG. 12 provides a partial cut-way isometric view of the spring actuated registration pin shown in FIG. 7; and

FIG. 13 provides a partial cut-away isometric view of the spring actuated registration pin shown in FIG. 10.

### DETAILED DESCRIPTION OF THE INVENTION

The Semiconductor Equipment and Materials Institute (SEMI) has created Standards for workpiece (e.g., semiconductor wafer) storage containers. Two examples of a workpiece storage container include a Front Opening Unified Pod (FOUP) for storing 300 mm wafers and a Standard Mechanical Interface (SMIF) pod for storing 200 mm wafers. Other type of workpiece storage containers exist, and a SMIF pod and/or FOUP may be sized to store any number of wafers and wafer of various sizes (e.g., 150 mm wafers, 450 mm wafers, etc.).

For purposes of describing this invention, only FOUPs will be referenced herein. The various embodiments of the present invention may also be used and/or adapted for systems handling SMIF pods, reticle containers, flat panel display transport devices, or any other container or processing tool. Container is defined as any type of structure for supporting an article including, but not limited to, a semiconductor substrate. By way of example only, a container includes a structure that comprises an open volume whereby the article can be accessed (e.g., FPD transport) or a container having a mechanically openable door (e.g., bottom opening SMIF pod and FOUP).

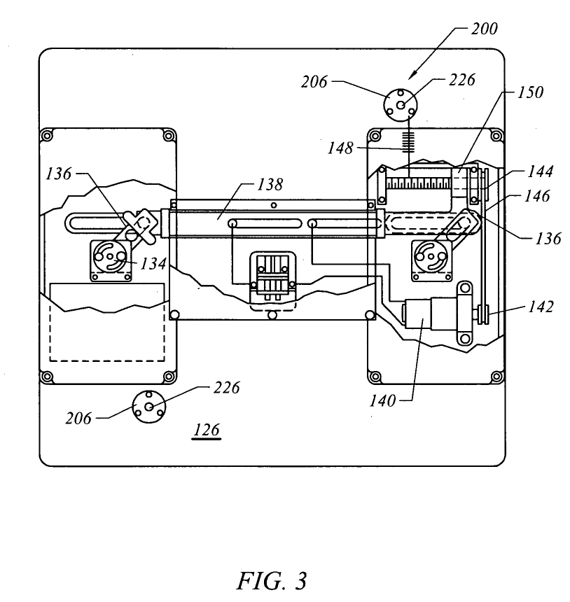

The present invention will now be described in combination with FIGS. 3-12. FIG. 3 illustrates one embodiment of a mechanism in the port door for actuating the latch keys 132. Other mechanisms for rotating the latch keys 132 are within the scope of the present invention. The latch keys 132 are affixed to respective latch key mounting assemblies 134, explained in greater detail below. An actuator 136 is fixedly mounted to each of the latch key bodies 143, which actuators 136 are connected to each other by a translating rod 138. In a preferred embodiment, once a FOUP is seated adjacent a port door 126 (as indicated for example by a pod-at-port sensor), a motor 140 drives a pair of pulleys 142 and 144 attached to each other via a timing belt 146. Pulley 144 is in turn attached to a lead screw 148 having a carriage 150 mounted thereon, which carriage moves back and forth along the lead screw upon the screw rotation. The carriage 150 is in turn connected to the translating rod 138 affixed to the actuators 136. Thus, rotation of the motor will cause translation of the rod 138 and a pivoting of the actuators 136 to thereby rotate the latch keys 132. As would be appreciated by those of skill in the art, various mechanisms and linkages may be substituted for those described above for transferring torque from the motor to the actuators 136 to thereby rotate the latch keys 132. One such latch key drive mechanism is disclosed in U.S. Pat. No. 6,502,869 entitled “Pod Door to Port Door Retention System,” which is assigned to Asyst Technologies, Inc., and is incorporated by reference in its entirety herein.

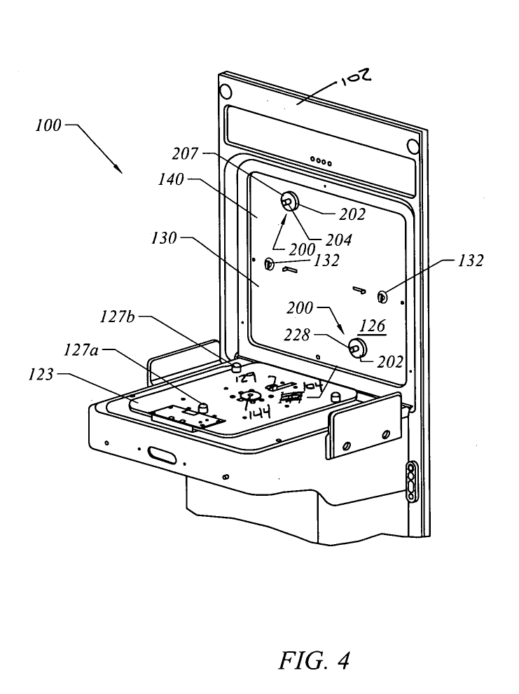

FIG. 4 illustrates an embodiment of a load port 100. The load port 100 includes a plate 102 having an opening 104, port door 126 having a front face 130 and a FOUP advance plate 123 having three kinematic pins 127. The load port 100 also includes a latch 129 for securing the FOUP 20 to the FOUP advance plate 123 and a sensor 144 for detecting whether a FOUP 20 is seated on the FOUP advance plate 123. The port door 126 moves between a closed position (shown in FIG. 4) and an open position whereby the port door 126 does not obstruct the opening 104. The load port door 126 also includes a pair of retention mechanisms 200 and latch keys 132 extending out from the face 130. The retention mechanisms 200, as will be described in more detail later, prevent or minimize the FOUP door 22 from moving relative to the port door 126 while the FOUP door 22 and port door 126 are coupled together.

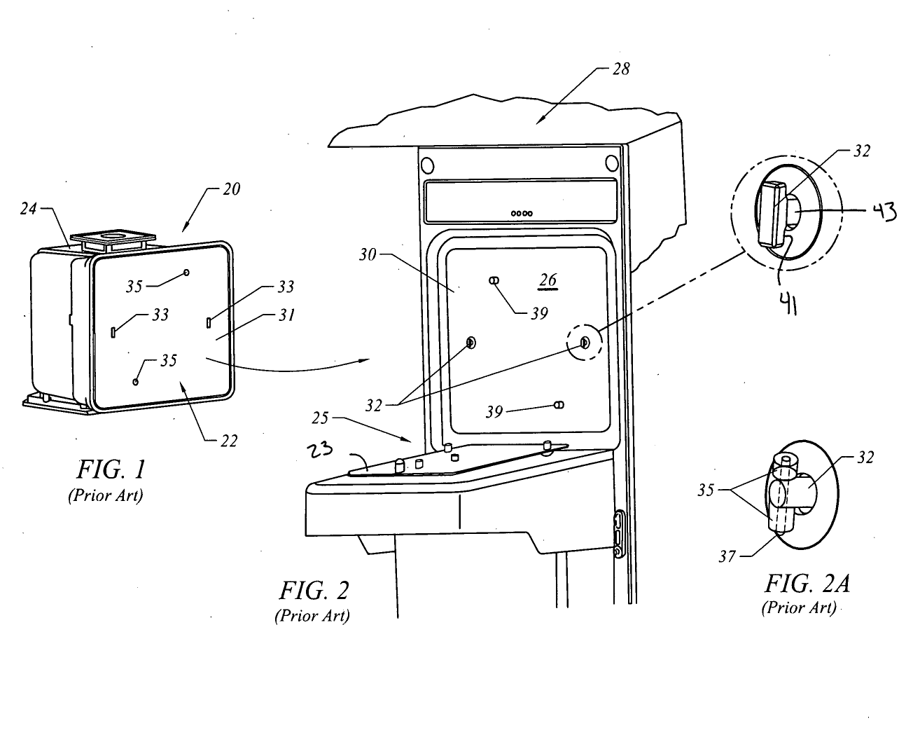

FIG. 4 illustrates each retention mechanism 200 located in the port door 126 in the same position as the registration pins 39 are shown in the port door 26 in FIG. 1. The retention mechanisms 200 therefore replace the registration pins 39. The port door 126 may include the retention mechanisms 200 elsewhere on the face 130 in addition to registration pins. When the retention mechanisms 200 replace the registration pins 39, each retention mechanism 200 preferably includes a registration pin 204 to effectively replace the registration pin 39. If the port door 126 includes retention mechanisms 200 in addition to registration pins 39, the retention mechanisms 200 do not include a registration pin themselves. Regardless, the retention mechanism 200 provides a spring force to create enough friction between the FOUP door 22 and the back surface 141 of each latch key 132 to prevent the FOUP door 22 from moving relative to the port door 126.

FIG. 4 illustrates that each retention mechanism 200 includes a plunger 202 and a registration pin 204 extending out from the face 130 of the port door 126. The plunger 202, as will be described in more detail later, essentially pushes the FOUP door 22 away from the port door 126 after the doors are coupled together. The registration pin 204 of each retention mechanism 200 is preferably aligned with the location features or slot 33 of a conventional FOUP door 22 (see FIG. 1) while the FOUP 20 is seated on the container advance plate 123. This way, the FOUP 20 does not have to be modified to operate with the load port door 126 of the present invention.

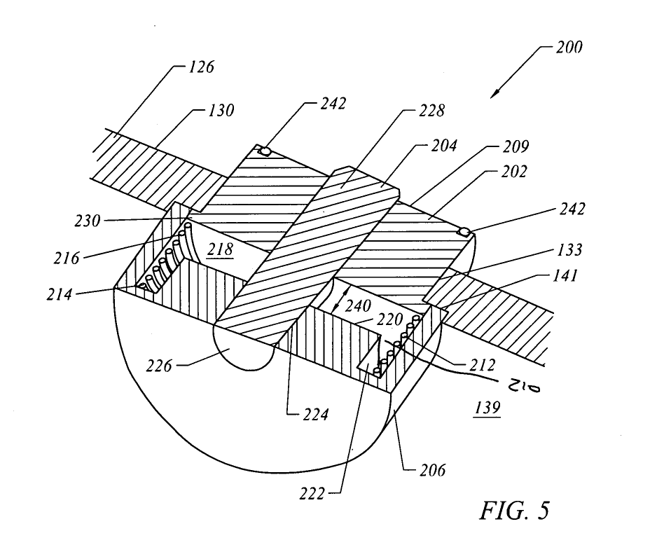

FIG. 5 illustrates the retention mechanism 200 shown in FIG. 4 in more detail. The retention mechanism 200 includes a reciprocating body or plunger 202, a registration pin 204, a stationary body 206 and a coil spring 212. The plunger 202 includes a flange or collar 230 at the base of the plunger 202, a hole 203 extending through it to accommodate the registration pin 204 and a front face 209. The registration pin 204 preferably conforms to the SEMI Standard 9 mm diameter for a registration pin. In this embodiment, the reciprocating body 202 and the stationary body 206 are concentric with the registration pin 204.

The port door 126 includes a machined bore 133 and a recessed surface 141 to accommodate the plunger 202 and stationary body 204 of the retention mechanism 200. In this embodiment, the stationary body 206 is seated within the recessed surface 141 and is affixed to the rear surface 139 of the port door 126.

The stationary body 206 includes a cavity 210 for housing, in this example, a coil spring 212. The cavity 210 includes a raised central portion 219 having a top surface 220 surrounded by a circular channel 222. The raised central portion 219 includes a bore or hole 224 for accepting the proximal end 226 of the registration pin 204. The coil spring 212 is seated within the channel 222. The coil spring 212 is compressed slightly even when the plunger 202 is fully extended (as shown in FIG. 5) to ensure that the coil spring is always in contact with the bottom 218 of the plunger 202 and biases the plunger 202 outward from the face 130 of the port door 126. The reciprocating body 202 translates along the registration pin 204 within the hole 133 in the port door 126.

FIG. 5 illustrates that the top surface 209 if the plunger 202 may also include an o-ring 242 to soften the contact between the top surface 209 of the plunger 202 and the face 31 of the FOUP door 22. By way of example only, the o-ring 242 comprises a synthetic rubber. A conventional FOUP comprises a polycarbonate FOUP door and shell. By way of example only, the plunger 202 may comprise Delrin® plastic. The coefficient of friction of Delrin plastic is lower than synthetic rubber. The o-ring 242 therefore provides a higher friction contact surface than the face 209 of the plunger 202. Thus, the coil spring 212 must produce a greater spring force to hold the face 209 of the plunger 202 against the FOUP door 22 than to hold the o-ring 242 against the FOUP door 22.

The flange 230 at the base of the reciprocating body 202 functions as a stop to prevent the coil spring 212 from pushing the reciprocating body 202 out of the load port door 126. The range of motion of the reciprocating body 202 is shown in FIG. 5 as distance 240. FIG. 5 shows the plunger 202 in a fully extended position. The plunger 202 may be compressed until the bottom surface 218 of the plunger 202 contacts the surface 220 of the stationary body 206.

The retention mechanism 200 minimizes or prevents the FOUP door 22 from moving relative to the port door 126 while the doors are coupled together regardless of how the load port removes the FOUP door from the FOUP. The operation of the retention mechanism 200 is described herein with a load port that removes the FOUP door 22 from the FOUP 20 by moving the FOUP towards a stationary port door. In operation, a FOUP 20 is seated on the container advance plate 123. After the FOUP 20 is secured to the container advance plate 123 (e.g., by latch 129), the container advance plate 123 moves the FOUP 20 towards the load port door 126. As the FOUP 20 approaches the load port door 126, the registration pin 204 is the first component of the port door 126 to engage the FOUP. The registration pin 204 enters the location features 35 of the FOUP door 22. As the FOUP 20 continues to move towards the port door 126, the distal end 209 of the reciprocating body 202 eventually contacts the face 30 of the FOUP door 22 (or the o-ring 242 if the plunger 202 includes an o-ring 242).

At this first point of contact between the plunger 202 and the FOUP door 22, the latch keys 132 are not inserted into the slots 33. As the FOUP 20 continues to move towards the load port door 126, the FOUP door 22 compresses the reciprocating body 202 into the cavity 210 of the stationary body 206. Compressing the plunger 202 also compresses the coil spring 212.

The FOUP 20 continues to move towards the port door 126 until the latch keys 132 are inserted into the slots 33 in the FOUP door 22. The latch keys 132 then rotate to couple the FOUP door 22 to the port door 126. When the latch keys 132 initially couple the FOUP door 22 to the port door 126, the face 130 of the port door 126 is nearly in contact with, or barely touching, the face 30 of the FOUP door 22.

As discussed above, the diameter of the registration pin 204 preferably comprises 9 mm. However, the diameter of the location feature 35 in the FOUP door 22 varies per manufacturer and is typically larger than 9 mm. Thus, at this point, if a conventional port door 126 began to retract to remove the FOUP door 22 from the FOUP 20, the FOUP door 22 would shift vertically slightly relative to the port door 126 until the wall 37 of the location feature 35 rested on the registration pin 204. This slight vertical shift of the FOUP door 22 can make it difficult to replace the FOUP door 22 back into the FOUP 20. For example, the FOUP door 22 may scrape the FOUP shell 24 as the FOUP door 22 is placed back into the FOUP; causing particles that may damage the wafers stored within the FOUP.

The retention mechanism 200 minimizes or prevents the FOUP door 22 from moving relative to the port door 126. After the latch keys 132 couple the port door 126 and the FOUP door 22 together (e.g., by rotating the latch keys 90°), the port door 126 retracts from the FOUP 20 to remove the FOUP door 22. The compressed coil spring 212 is pressing the face 209 (or the o-rings 242) of the reciprocating body 202 against the face 31 of the FOUP door 22. As the port door 126 retracts from the FOUP 20, the coil spring 212 pushes the plunger 202 against the FOUP door 22 away from the face 130 of the port door 126 until the FOUP door 22 is pressed firmly against the back surface 141 of the latch keys 132. The distance between the face 130 of the port door 126 and the face 31 of the FOUP door 22 is preferably less than the distance 240 to ensure that the plunger 202 is applying enough force against the face 31 of the FOUP door 22 to prevent the FOUP door from slipping vertically relative to the port door. In a preferred embodiment, the face 30 of the FOUP door 22 is separated from the face 131 of the port door 126 by less than 2 mm. The doors may be separated by other distances.

The coil spring 212 and plunger 202 essentially pushes the FOUP door 22 away from the port door 126 to prevent the FOUP door 22 from moving relative to the port door 126 once the FOUP door 22 has been removed from the FOUP 20. The retention mechanism 200 also operates if the port door 126 engages a stationary FOUP door 22. The spring-loaded body 202 is insensitive to loss of vacuum or power to the load port, which provides an advantage over vacuum-based retention of the FOUP door.

As discussed above, the load port door 126 may include a pair of retention mechanisms 200 elsewhere on the port door 126 in addition to the registration pins 39. If the retention mechanisms 200 are additional features, the retention mechanism 200 shown in FIG. 5 would likely not include a registration pin 204. The registration pins 39 would insert into the location features 35 of the FOUP door 22 similar to a conventional load port door. Without a registration pin, the plunger 202 comprises a solid piece of material. The coil spring 212 still exerts a force on the plunger 202 sufficient to push the FOUP door 22 away from the port door 126.

Other embodiments of retention mechanisms include spring-plunger devices to stabilize and retain the FOUP door may be implements by other means than described above, namely: (1) the whole surface of the load port door may be sprung against the FOUP door face, or (2) the individual plungers may be located in other locations besides the vacuum cup locations, for instance concentrically to the latch keys, or (3) the load port door may incorporate at least two leaf springs or a gasket recessed into its face and positioned to press on the edges of the FOUP door (or other areas), or (4) the plungers may take the form of smaller diameter pins which press on areas of the FOUP door, for instance at four symmetrically located positions around the edge of the FOUP door.

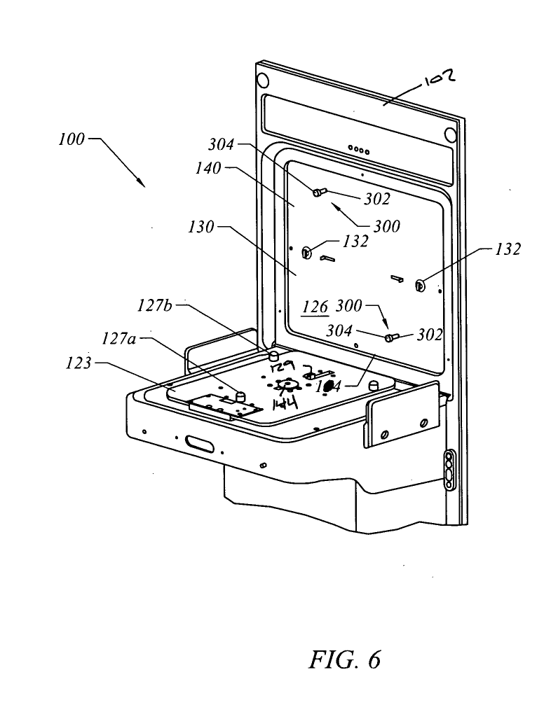

FIG. 6 illustrates the port door 126 having a pair of retention mechanisms 300. Each retention mechanism is essentially a spring-actuated registration pin 302 for preventing the FOUP door 22 from moving relative to the port door 126 after being unlocked from the FOUP. FIG. 6 illustrates that the registration pins 302 may replace the registration pins 39 shown in FIG. 1. Thus, the registration pins 302 engage the location features 35 in the FOUP door 22. The load port door 126 may include spring-actuated pins 302 in addition to the registration pins 39.

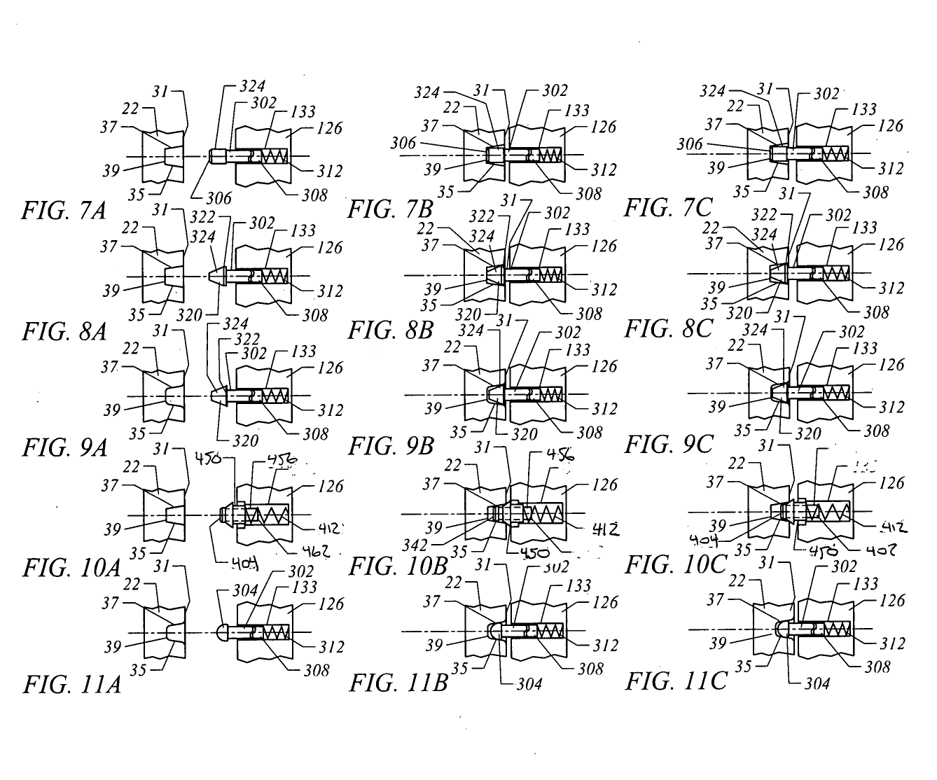

FIGS. 7-11 provide schematic illustrations of various embodiments of a spring actuated registration pin 302. FIGS. 7A-7C illustrate the registration pin 302 shown in FIG. 6. FIGS. 8-9 illustrate a registration pin 302 having a tapered tip 320. FIG. 9 illustrates a registration pin having a reciprocating sleeve 450. FIG. 10 illustrates a registration pin 302 having a spherical tip 314.

FIG. 7A illustrates the registration pin 302 in a fully extended. The registration pin 302 includes a cylindrical tip 304 having a body 308 extending rearward therefrom. The cylindrical tip 304 has a distal end 306 with a tapered edge 307 (optional). FIG. 7A shows the FOUP door 22, which includes a location feature 35, facing the port door 126. The location feature 35 comprises a tapered recess in the FOUP door 22 having a side wall 37 and a bottom surface 39. As discussed above, the diameter of the location feature 35 at the point flush with the face 31 of the FOUP door 22 is typically larger than the diameter of the tip 304. Even the diameter of the bottom surface 39 of a location feature 35 is often slightly larger than the diameter of the pin body 308. In this embodiment, the tip 304 of the registration pin 302 complies with the 9 mm diameter SEMI Standard and the body 308 is narrower. Of course, the body 308 may also comply with the 9 mm diameter SEMI Standard.

FIG. 7B illustrates an exemplary FOUP door engaged position. In this position, the FOUP 20 (or the port door 126) has been moved forward to a position whereby the latch keys 132 are inserted into the latch key holes 33 of the FOUP door 22 and the latch keys 132 may rotate to unlock the FOUP door 22 from the FOUP shell 24. At this point, the tip 304 of the registration pin 302 is inserted completely into location feature 35, and in a preferred embodiment, is centered in the location feature 35. In this embodiment, the diameter of the cylindrical tip 304 is slightly less than the diameter of the bottom surface 39. Thus, the distal end 306 of the cylindrical tip 304 contacts the bottom surface 39 of the location feature 35. As discussed above, at this point, the face 31 of the FOUP door 22 and the face 131 of the port door 126 are nearly in contact with, or barely touching, each other.

FIG. 7C illustrates an exemplary FOUP retained position. In this position, the port door 126 has rotated the latch keys 132 to couple the FOUP door 22 to the port door 126, and the port door has retracted slightly from the FOUP door 22. As the port door 126 retracts, the coils spring 312 pushes the registration pin 302 against the FOUP door 22; away from the port door 126. The tip 304 preferably remains centered within the location feature 35 of the FOUP door 22. The FOUP door 22 is pushed against the back surface of the latch keys (not shown) to preferably prevent or minimize motion of the FOUP door 22 relative to the port door 126. If the spring 312 does not provide enough force, the FOUP door 22 may slip slightly (e.g., less than 1 mm). The separation between the FOUP door 22 and the port door 126 shown in FIG. 7C is preferably 2 mm or less. The FOUP door remains in this fixed position as the port door 126 moves the FOUP door into the processing tool.

FIGS. 8A-8C illustrate a registration pin 302 having a cone-shaped tip 320. The location feature 35 in the FOUP door 22 has a tapered wall 37 similar to the location feature shown in FIG. 7A. In this embodiment, the diameter of the tip's proximal end 322 is larger than the diameter of the tip's distal end 324. The diameter of the tip base 322 is slightly smaller than the diameter of the location feature 35 where the location feature is flush with the face 31 of the FOUP door 22. The diameter of the tip base 322 is however larger than the diameter of the bottom surface 39.

FIG. 8B illustrates the FOUP door 22 located in a FOUP door engaged position. In this position, the cone-shaped tip 320 of the registration pin is located completely inside the location feature 35. However, the tip's distal end 324 does not contact the bottom surface 39 of the location feature 35. Instead, the tip base 322 contacts the side wall 37 of the location feature 35 as the tip 320 moves towards the bottom 39. The tapered configuration of the tip 320 and the side wall 37 preferably center the registration pin 302 within the location feature 35. As the doors move closer together, the registration pin 302 compresses the coils spring 312 and the latch keys 132 insert into the slots 33 in the FOUP door 22 and rotate to couple the doors together.

FIG. 8C illustrates an exemplary FOUP retained position. In this position, the coil spring 312 has pushed the registration pin 302 (which remains in the location feature 35) against the FOUP door, and pushed the FOUP door 22 against the back of the latch keys (not shown). The distance between the FOUP door 22 and the port door 126 shown in FIG. 8C is preferably less than 2 mm. The coil spring 312 produces enough force to push the registration pin 302 against the FOUP door to maintain the FOUP door 22 in this fixed position relative to the port door 126.

FIGS. 9A-9C illustrate the registration pin 302 shown in FIGS. 8A-8C. FIGS. 9A-9C, however, illustrate a FOUP door 22 with a location feature 35 having a contoured side wall 37. The diameter of the contoured side wall 37, at the face 31 of the FOUP door 22, is less than the diameter of the proximal end of the cone-shaped tip 320 of the registration pin. In the FOUP Door engaged position, as shown in FIG. 9B, the tip 320 of the registration pin cannot fit completely within the location feature 35. The side wall of the tip 320 contacts the side wall 37 of the location feature 35 before the tip 320 contacts the bottom 39 of the location feature 35. FIG. 9C illustrates an exemplary FOUP retained position. In this position, the pin has pushed the FOUP door 22 away from the port door 126 and against the back of the latch keys (not shown) to prevent or minimize motion of the FOUP door 22 relative to the port door 126.

FIGS. 10A-10C illustrate a retention mechanism 400. The retention mechanism 400 includes a reciprocating sleeve 450 guided by a stationary registration pin 402. The sleeve 450 includes a cone-shaped tip 452 having a tapered surface 454 and a body 456 extending rearward therefrom. The base 458 of the tip 452 has a larger diameter than the diameter of the body 456. Thus, the base 458 of the tip 450 hangs over the body 456 and forms an overhang 460. A coil spring 412 contacts the body 456 and biases the sleeve 450 outward (see FIG. 10A). As the FOUP moves (or port door moves) into the FOUP door engaged position (shown in FIG. 10B), the tip 404 of the registration pin 402 enters the location feature 35 and the tapered surface 454 of the sleeve tip 452 contacts the outer wall 37 of the FOUP's location feature 35.

As the FOUP door 22 moves closer to the port door 126 (or the port door moves closer to the FOUP door), the sleeve 450 is pushed back into the housing 480 and compresses the coil spring 412 until the position shown in FIG. 10B. The sleeve 450 preferably centers/aligns the FOUP door location feature 35 on the registration pin 402. FIG. 10C illustrates an exemplary FOUP retained position. In this position, the port door 126 has retracted slightly from the FOUP door 22. While the port door 126 moves away from the FOUP door 22, the coil spring 412 urges the sleeve 450 against the FOUP door 22 and against the back of the latch keys.

FIGS. 11A-11C illustrate a registration pin having a spherical-shaped tip 304. In this embodiment, the location feature 35 is contoured similar to the location feature shown in FIG. 9A. In the FOUP door engaged position, as shown in FIG. 11B, the tip 304 of the registration pin fits completely within the location feature 35 even though side wall of the tip 304 contacts the side wall 37 of the location feature 35. The tip 304 is not required to fit completely within the feature 35 in the FOUP door 22.

FIG. 11C illustrates an exemplary FOUP retained position. In this position, the pin has pushed the FOUP door 22 away from the port door 126 and against the back of the latch keys (not shown) to prevent or minimize motion of the FOUP door 22 relative to the port door 126. The separation between the FOUP door 22 and the port door 126 shown in FIG. 11C is greater than the separation between the two doors shown in FIG. 11B.

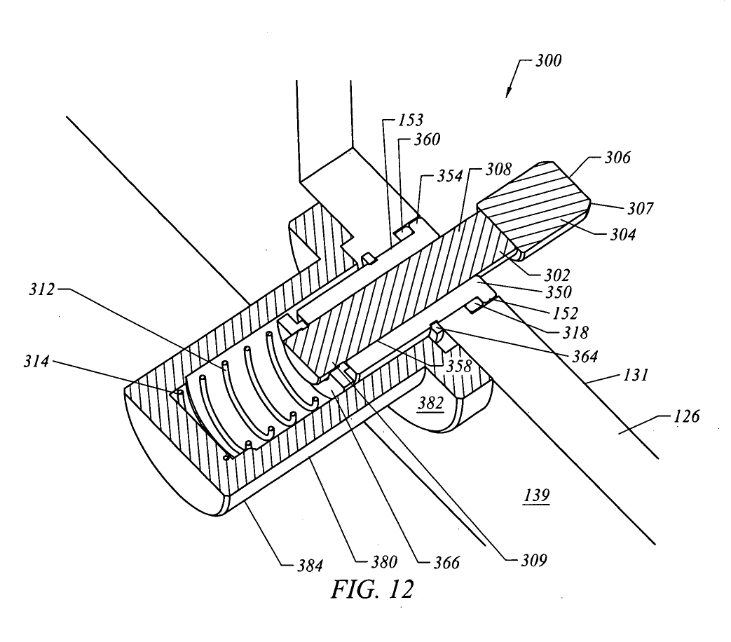

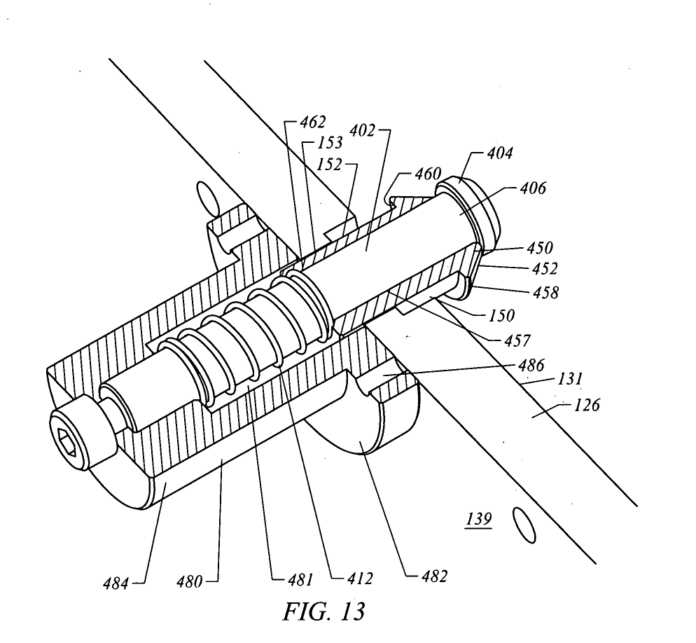

FIG. 12 illustrates the retention mechanism 300 shown in FIG. 7 in more detail. The retention mechanism 300 includes a registration pin 302, a coil spring 312, a sleeve 350, a plunger 366 and a housing 380. The retention mechanism 400 may include other spring mechanism such as, but not limited to, a leaf spring. The retention mechanism 300 may comprise a preassembled package that snaps into the port door 126 or separate elements that must be assembled.

The registration pin 302 includes a tip 304 having a shaft 308 extending rearward therefrom. FIG. 12 illustrates that the diameter of the tip 304 is greater than the diameter of the shaft 308. The shaft 308 and tip 304 may have substantially similar or identical diameters to meet, for example, the current SEMI Standard requiring the entire registration pin 302 to have a single diameter comprising 9 mm. The distal end 306 of the tip 304 includes a tapered edge 307 to help the tip 304 center itself within the location feature 35 of the FOUP door 22. The tapered edge 307 is not required.

The port door 126 has a machined bore 150 to accommodate the sleeve 350. The bore 150 comprises a first bore 152 partially through the port door 126 and a second bore 153, having a smaller diameter than the first bore 152, extending completely through the port door 126. The stepped diameter bore 150 creates a shelf 156 at the bottom of the first bore 152. The sleeve 350 includes a body 356 having a flange or collar 354 and a hole 358 extending through the body 356. The diameter of the flange 354 is greater than the diameter of the body 358. A snap-ring 360 is inserted into the port door 126 to retain the sleeve 350 and locate the flange 354 flush with the face 131 of the port door 126. The snap-ring 360 includes, in this embodiment, a first retaining ring 362 and a second retaining ring 364. The first retaining ring 362 comprises a spacer to ensure that the flange 354 is flush with the face 131 of the port door 126. The second retaining ring 364 engages a notch or channel 318 in the sleeve body 356 to prevent the sleeve 350 from translating within the port door 126.

The registration pin 302 reciprocates within the hole 358 of the sleeve 350. FIG. 12 illustrates that a plunger 366 is affixed to the distal end 311 of the registration pin shaft 308. The plunger 366 has two basic functions. The plunger 366 compresses the coil spring 312 as the pin 302 is pushed into the housing 380. The plunger 366 also acts as a stop mechanism. The coil spring 312 may push the registration pin 302 away from the port door 126 until the plunger 366 contacts the sleeve body 356. The cylindrical housing 380 is affixed to the back surface 139 of the port door 126. The housing 380 encloses the coil spring 312, and fits over the sleeve 350, the plunger 366 and the registration pin body 308 to prevent particles generated by the retention mechanism 300 from entering the interior of the load port.

The housing 380 includes a base 382 and a column 384 extending from the base 382. The base 382 preferably has a larger diameter than the column 384 to provide a surface to attach the base 382 to the rear face 139 of the port door 126. The housing 380 may, of course, be affixed to the rear face 139 of the port door 126 by any means know within the art. The coil spring 312 seated within the column 384 biases the plunger 366, and therefore the registration pin 302, outward from the face 131 of the port door 126 (as shown in FIG. 12).

In operation, the retention mechanism 300 prevents or minimizes the FOUP door 22 from moving relative to the port door 126 after the doors are coupled together. Initially, a FOUP 20 is seated on the FOUP advance plate 123 (see FIG. 6). A latch mechanism 129 in the FOUP advance assembly secures the bottom of the FOUP 20 to the FOUP advance plate 123. The FOUP advance plate 123 then moves the FOUP 20 towards the port door 126 until the port door latch keys 132 are proximate to the latch key slots 33 in the FOUP door 22. At this point, either the FOUP continues to move towards the port door or the port door moves towards the FOUP door. Either way, the latch keys 132 enter the latch key slots 33 and rotate to couple the FOUP door 22 to the port door 126. The retention mechanism 300 maintains the FOUP door 22 in a fixed vertical position through either method of operation.

In the instance where the port door 126 moves towards a stationary FOUP 20, the tip 324 of each registration pin 302 first enters the location features 35 in the FOUP door 22. The latch keys 132 are likely not inserted into the latch key slots 33 when the registration pin 302 first enters the location feature 35. As the port door 126 continues to move towards the FOUP door 22, the latch keys 132 insert into the latch key slots 33 and the tip 324 of each registration pin 302 eventually contacts the bottom 39 of the location feature 35 (in the FIG. 7A embodiment). Alternatively, the registration pin 302 may contact the side wall 37 of the location feature 35. As the port door 126 continues to move towards the FOUP door 22, the force exerted by the FOUP door 22 against the registration pin 302 overcomes the spring force of the coil spring 312 and the plunger 366 compresses the coil spring 312. The tip 324 of the registration pin 302 remains in contact with the location feature 35. The port door 126 continues to move forward until the latch keys 132 can rotate to couple the FOUP door 22 to the port door 126.

After the latch keys 132 rotate, the port door 126 retracts from the FOUP door 22. As the port door 126 retracts, the back of the latch keys 132 eventually contact the interior of the FOUP door. Any further rearward motion of the port door 126 will cause the latch keys 132 to remove the FOUP door 22 from the FOUP shell 24 by pulling the FOUP door 22 from the FOUP shell 24. The tip 324 of the registration pin 302 remains in the location feature 35 and the coil spring 312 continually urges the registration pin 302 into the location feature 35 as the port door 126 retracts from the FOUP door 22. The coils spring 312 pushes the FOUP door 22 against the back 141 of the latch keys 132 such that the friction force between the FOUP door 22 and the back 141 of the latch keys 132 is sufficient to prevent the FOUP door 22 from moving relative to the port door 126. In one embodiment, the coil spring may produce a 5-20 Newton force acting on the registration pin 302. Thus, when the port door 126 removes the FOUP door 22, the registration pin 302 urges the FOUP door 22 against the back 141 of the latch keys 132 and the doors are moved into the processing tool as a single unit.

FIG. 13 illustrates the retention mechanism 400 shown in FIG. 10 in more detail. The retention mechanism 400 may comprise a preassembled package that secures to the port door 126 or comprise separate elements that must be assembled. The retention mechanism 400 includes a registration pin 402, a coil spring 412, a reciprocating sleeve 450 and a housing 480. The registration pin 402 includes a tip 404 and a body 406 extending therefrom. The sleeve 450 includes a cone-shaped tip 452 having a tapered surface 454 and a body 456 extending rearward therefrom. The diameter of the base 458 is larger than the diameter of the body 456. Thus, the base 458 of the tip 450 hangs over the body 456 and forms an overhang 460. The sleeve 450 has a bore 457 extending through it to accommodate the registration pin 402.

The port door 126 includes a stepped diameter bore 150 to accommodate the sleeve 450. The first bore 152 extends partially through the port door 126 and comprises a diameter larger than the diameter of the sleeve tip base 458. A second bore 153 extends entirely through the port door 126 and is substantially the same diameter as the diameter of the sleeve body 456. The sleeve 450 reciprocates along the stationary registration pin 402 between an extended position (shown in FIG. 13) and a compressed position, whereby the tip 452 is flush with the face 131 of the port door 126 (the tip 452 is recessed fully within the bore 152).

A coil spring 412, located within the housing 380, is coiled around a portion of the body 406 of the registration pin 402 and contacts the distal end 462 of the sleeve body 456. The coil spring 412 biases the tip 452 of the sleeve 450 outward away from the port door face 131. The housing 480 includes a base 482 and a body 484 extending rearward therefrom. In this embodiment, the base 482 includes multiple bores 486 so that the housing 480 may be, for example, bolted the interior face 139 of the port door 126. The housing 480 may be attached to the port door 126 by other fasteners. The sleeve 450 may also be spring loaded within the housing by other devices such as, but not limited to, a leaf spring.

The operation of the retention mechanism 400 will be described in relation to the port door 126 moving towards the FOUP door 22. The retention mechanism 400 also operates in a system whereby the FOUP door 22 moves towards the port door 126. As the port door 126 moves towards the FOUP door 22, the tip 404 of the registration pin 402 enters the location feature 35 and the tapered surface 454 of the sleeve tip 452 eventually contacts the location feature outer wall 37. As the port door 126 moves closer to the FOUP door 22, the sleeve 450 is pushed back into the housing 480 and compresses the coil spring 412 until the port door latch keys 132 are inserted in the slots 33 in the FOUP door 22 and may rotate to couple the doors together. The sleeve 450 preferably self centers/aligns the location feature 35 with the registration pin 402.

After the latch keys 132 couple the FOUP door 22 to the port door 126, the port door 126 retracts slightly from the FOUP door 22. As the port door 126 moves away from the FOUP door 22, the coil spring 412 urges the tapered surface 452 of the sleeve 450 against the wall 37 of the location feature 35. In one embodiment, the coil spring 412 may produce a 5-20 Newton force acting on the sleeve 450. The port door 126 retracts until the back 143 of the latch keys 132 contact the FOUP door 22. At this point, the coil spring 412 provide enough force to push the sleeve 450 against the wall 37 and the FOUP door against the back of the latch keys 132. The coil spring 412 presses the sleeve 450 against the wall 37 hard enough to create a frictional force between the back 141 of the latch keys 132 and the FOUP door 22 to prevent the FOUP door from moving relative to the port door 126. Friction between tapered surface of the sleeve tip 452 and the wall 37 in the location feature 35.

It should be appreciated that the above-described embodiments of a port door and FOUP door are for explanatory purposes only and that the invention is not limited thereby. Having thus described preferred embodiments of a port door retention and sensor features, it should be apparent to those skilled in the art that certain advantages of the within system have been achieved. It should also be appreciated that various modifications, adaptations, and alternative embodiments thereof may be made within the scope and spirit of the present invention. For example, the port door has been illustrated in a semiconductor fabrication facility, but it should be apparent that many of the inventive concepts described above would be equally applicable to the use of other non-semiconductor manufacturing applications.

We claim:

1. A load port door for opening a container storing one or more workpieces associated with a semiconductor fabrication process, the container including a shell and vertically oriented front door having at least one latch key slot and at least one location feature, the load port door comprising:
a vertical surface;
at least one latch key protruding from said vertical surface capable of fitting within said at least one latch key slot, said at least one latch key capable of unlocking the container door from the container shell and coupling the container door with the port door; and
at least one retention mechanism protruding from said vertical surface, said at least one retention mechanism having a reciprocating body for pushing the container door away from said vertical surface in order to minimize the motion of the container door relative to the port door while the container door and port door are coupled together.

2. The load port door as recited claim 1, wherein said at least one latch key comprises two latch keys.

3. The load port door as recited claim 1, wherein said at least one retention mechanism comprises two retention mechanisms.

4. The load port door as recited claim 1, wherein said at least one retention mechanism comprises:
a registration pin extending from said vertical surface capable of fitting within a location feature in the container door; and
a spring-actuated plunger body for contacting the container door and pushing the container door away from said vertical surface.

5. The load port door as recited in claim 4, wherein said registration pin and said spring-actuated plunger body are concentric.

6. The load port door as recited in claim 1, wherein said at least one latch key rotates to couple the container door with the port door.

7. The load port door as recited in claim 1, wherein said at least one latch key comprises a key having a shaft extending rearward therefrom.

8. The load port door as recited in claim 7, wherein said reciprocating body pushes the container door against a vertical surface of said key while the container door is coupled to the port door.

9. The load port door as recited in claim 7, wherein said at least one latch key rotates 90° between a first position whereby said key aligns with the latch key slot in the container door and a second position whereby said key is perpendicular to the latch key slot in the container door.

10. A load port door for opening a container storing one or more workpieces associated with a semiconductor fabrication process, the container including a shell and vertically oriented front door having at least one latch key slot and at least one location feature, the load port door comprising:
a vertical surface;
at least one latch key protruding from said vertical surface capable of fitting within said at least one latch key slot of the container, said at least one latch key capable of unlocking the container door from the shell and coupling the container door with the port door; and
at least one spring-actuated registration pin protruding from said vertical surface capable of engaging the location feature in the container door, said at least one spring-actuated registration pin translates within the port door for pushing the container door away from said vertical surface in order to minimize the motion of the container door relative to the port door while the container door and port door are coupled together.

11. The load port door as recited in claim 10, wherein said at least one registration pin comprises a tip having a shaft extending rearward therefrom.

12. The load port door as recited in claim 11, wherein said tip comprises a cylindrical shape.

13. The load port door as recited in claim 11, wherein said tip comprises a conical shape.

14. The load port door as recited in claim 11, wherein said tip comprises a spherical shape.

15. The load port door as recited in claim 10, wherein said at least one spring-actuated registration pin comprises:
a shaft protruding from said vertical surface, said shaft forming a tip at a distal end having a diameter greater than the diameter of said shaft;
a conical sleeve fitted over said shaft; and
a spring affixed to said conical sleeve.

16. The load port door as recited in claim 15, wherein said spring biases said conical sleeve towards said tip of said shaft.

17. The load port door as recited in claim 10, wherein said at least one latch key comprises two lath keys.

18. The load port door as recited claim 10, wherein said at least one spring-actuated registration pin comprises two spring-actuated registration pins.

19. The load port door as recited claim 10, wherein said at least one registration pin comprises a tip having a shaft extending rearward therefrom.

20. The load port door as recited in claim 10, wherein said at least one latch key rotates to couple the container door with the port door.

21. The load port door as recited in claim 10, wherein said at least one latch key comprises a key having a shaft extending rearward therefrom.

22. The load port door as recited in claim 10, wherein said at least one registration pin pushes the container door against a vertical surface of said key while the container door is coupled to the port door.

23. The load port door as recited in claim 10, wherein said at least one latch key rotates 90° between a first position whereby said key aligns with the latch key slot in the container door and a second position whereby said key is perpendicular to the latch key slot in the container door.
